(19) United States
(12) Patent Application Publication
(10) Pub. No.: US 2015/0088313 A1
(43) Pub. Date: Mar. 26, 2015

(54) APPARATUS MANAGEMENT SYSTEM, APPARATUS MANAGEMENT DEVICE, AND CONTROL METHOD

(71) Applicant: Noriaki HAMADA, Kanagawa (JP)

(72) Inventor: Noriaki HAMADA, Kanagawa (JP)

(73) Assignee: RICOH COMPANY, LTD., Tokyo (JP)

(21) Appl. No.: 14/477,111

(22) Filed: Sep. 4, 2014

(30) Foreign Application Priority Data
Sep. 26, 2013 (JP) 2013-200495
May 15, 2014 (JP) 2014-101448

(51) Int. Cl. G05B 13/02; G05D 25/02; G05D 27/02; G05D 23/19

(52) U.S. Cl. CPC G05B 13/02; G05D 23/1917; G05D 25/02; G05D 27/02
USPC 700/275

(57) ABSTRACT

Disclosed is an apparatus management device configured to manage one or more apparatuses that control a work environment of a workspace. The apparatus management device includes a storage part configured to store an associated relationship between the users and parameters indicating the work environment, an apparatus management part configured to specify a user in the workspace from an image of the workspace, a calculating part configured to calculate a setting value for controlling the work environment based on a parameter stored in association with the user specified by the apparatus management part, and a transmitting part configured to transmit the setting value calculated by the calculating part to one of the apparatuses that control the work environment.

### BACKGROUND OF THE INVENTION

1. Field of the Invention

The disclosures herein generally relate to an apparatus management system, an apparatus management device, and a control method.

2. Description of the Related Art

There are apparatus management systems known in the related art that are able to control various types of apparatuses such as air-conditioners and lighting apparatuses for the purpose of reduction in electric power consumption in workspaces within an office (e.g., Patent Document 1). Such apparatus management systems may reliably control the electric power consumption in the office.

In the related-art, a work environment such as a temperature or a lighting level of each workspace is not necessarily comfortable for all the employees (all the users) in each of the workspaces.

Further, a comfortable temperature or lighting level for one of employees is not necessarily felt as comfortable by the other employees.

### PATENT DOCUMENT

### Related Art Document

### Patent Document

Patent Document 1: Japanese Laid-open Patent Publication No. 2004-360925

### SUMMARY OF THE INVENTION

Accordingly, it is a general object in one embodiment of the present invention to provide an apparatus management system, an apparatus management device, and a control method that is capable of improving comfortableness of a workspace that substantially obviates one or more problems caused by the limitations and disadvantages of the related art.

In one aspect of the embodiment, there is provided an apparatus management device configured to manage one or more apparatuses that control a work environment of a workspace. The apparatus management device includes a storage part configured to store an associated relationship between the users and parameters indicating the work environment; an apparatus management part configured to specify a user in the workspace from an image of the workspace; a calculating part configured to calculate a setting value for controlling the work environment based on a parameter stored in association with the user specified by the apparatus management part; and a transmitting part configured to transmit the setting value calculated by the calculating part to one of the apparatuses that control the work environment.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an overall configuration of an apparatus management system according to an embodiment;

FIG. 2 is a diagram illustrating a hardware configuration of the apparatus management device according to the embodiment;

FIG. 3 is a diagram illustrating examples of employees' information to be stored in the apparatus management device;

FIG. 4 is a diagram illustrating examples of layout information to be stored in the apparatus management device;

FIG. 5 is a flowchart illustrating an apparatus management process performed by the apparatus management device;

FIGS. 6A and 6B are diagrams illustrating air-conditioning sections and lighting control sections of a control area;

FIG. 7 is a flowchart illustrating a facial recognition process performed by a facial recognition part;

FIG. 8 is a diagram illustrating an example of a captured image;

FIG. 9 is a diagram illustrating respective identification numbers of employees in the control area;

FIG. 10 is a flowchart illustrating an environmental management process performed by an environment manager;

FIG. 11 is a diagram illustrating appropriate temperatures and appropriate lighting levels registered by the employees in the control area;

FIGS. 12A and 12B are diagrams illustrating target temperatures of control sections and appropriate lighting levels of control sections of the control area;

FIG. 13 is a flowchart illustrating an apparatus control process performed by an apparatus controller; and

FIG. 14 is a diagram illustrating another functional configuration of an apparatus manager.

### DETAILED DESCRIPTION OF THE PREFERRED EMBODIMENTS

In the following, a description is given of embodiments of the present invention with reference to the accompanying drawings. Note that duplicated descriptions may be omitted by assigning identical reference numerals to those components having substantially the same functional configurations in the specification and the drawings of the present application.

### First Embodiment

### Overall Configuration of Apparatus Management System

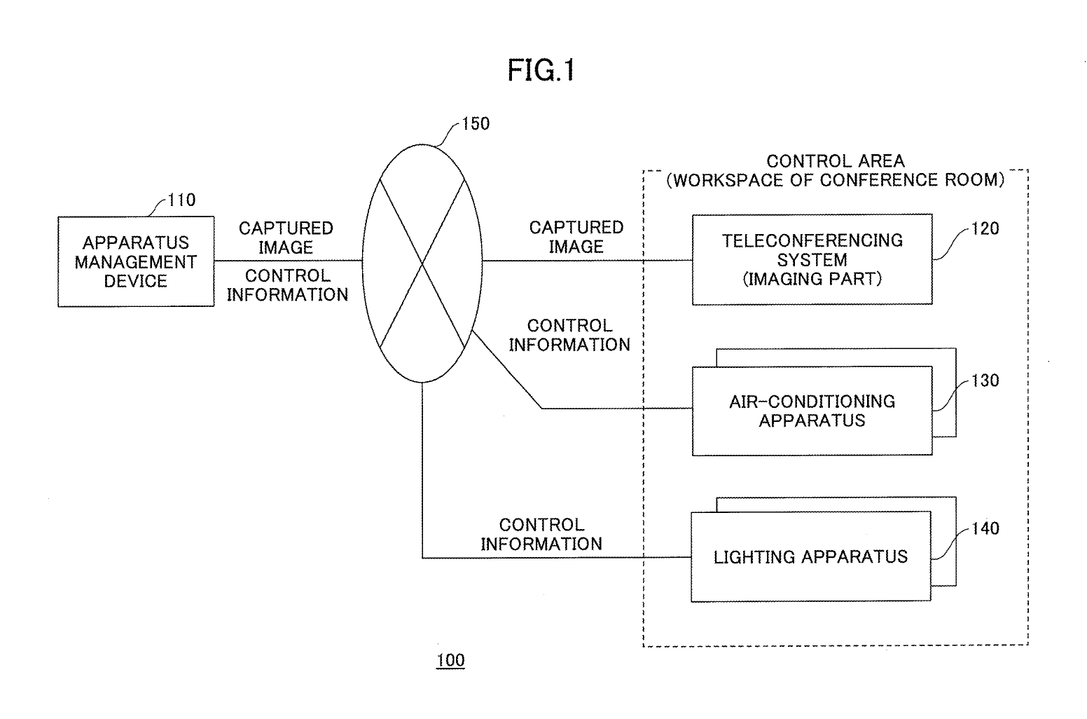

Initially, a description is given of an overall configuration of an apparatus management system according to embodiments. FIG. 1 is a diagram illustrating an overall configuration of an apparatus management system 100.

As illustrated in FIG. 1, the apparatus management system 100 includes an apparatus management device 110, a teleconferencing system 120, air-conditioning apparatuses 130, and lighting apparatuses 140, which are mutually connected via a network 150. Note that it is assumed that the teleconferencing system 120, the air-conditioning apparatuses 130, and the lighting apparatuses 140 are installed in a predetermined control area of which the employees' work environment (e.g., a predetermined workspace such as conference room within an office) is controlled.

The apparatus management device 110 is configured to receive an image captured by the teleconferencing system 120 via the network 150 and process the captured image. Further, the apparatus management device 110 resides in the same control area as the teleconferencing system 120 and is configured to transmit control information in accordance with a processed result of the captured image to the air-conditioning apparatuses 130 and the lighting apparatuses 140 that control the employees' work environment of the control area.

The teleconferencing system 120 includes an imaging part configured to image the employees (users) in the control area where the teleconferencing system 120 is installed, and to transmit the captured image to the apparatus management device 110. Note that the apparatus management system 100 may have any imaging part installed in the control area and having a function capable of performing communications and capable of imaging the employees in the control area. Such an imaging part is not limited to the teleconferencing system 120.

Note that when the control area is a conference room, a teleconferencing system may have already been installed in the conference room. Thus, it is not necessary to install an additional imaging part to connect the additional imaging part to the network 150 when using the existing teleconferencing system for constructing the apparatus management system 100. That is, it may be advantageous to use the existing teleconferencing system to construct the apparatus management system 100 because an initial cost may be reduced.

Each of the air-conditioning apparatuses 130 is configured to control a temperature of the control area and to operate based on the control information transmitted by the apparatus management device 110. Note that the number of air-conditioning apparatuses 130 is not limited to one in one control area, and may be two or more in the control area.

Each of the lighting apparatuses 140 is configured to control a lighting level of the control area and to operate based on the control information transmitted by the apparatus management device 110. Note that the number of lighting apparatuses 140 is not limited to one in one control area, and may be two or more in the control area.

### Configuration of Apparatus Management Device

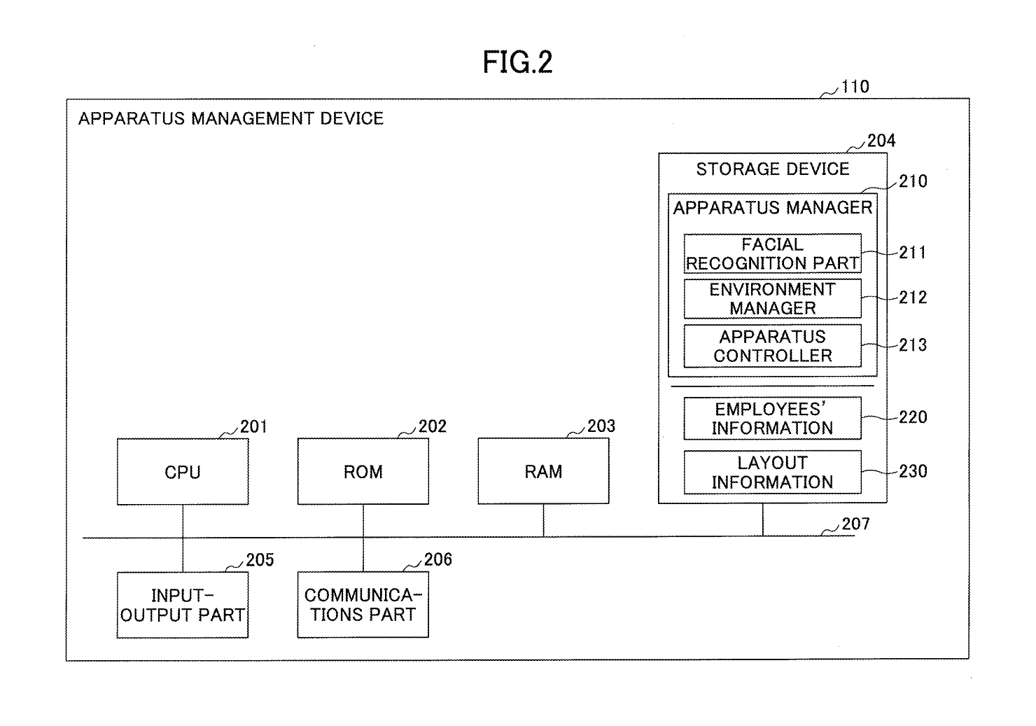

Next, a description is given of a hardware configuration of the apparatus management device 110. FIG. 2 is a diagram illustrating a hardware configuration of the apparatus management device 110.

As illustrated in FIG. 2, the apparatus management device 110 includes a central processing unit (CPU) 201, a read-only memory (ROM) 202, a random access memory (RAM) 203, and storage device 204. The apparatus management device 110 further includes a communications part 206. Note that the above components of the apparatus management device 110 are mutually connected via a bus 207.

The CPU 201 is a computer configured to execute a program stored in the storage device to function as an apparatus manager 210. When the CPU 201 executes the program functioning as the apparatus manager 210, the apparatus management device 110 receives the captured image from the teleconferencing system 120 installed in a specified control area. Further, the apparatus management device 110 processes the received image and transmits control information in accordance with the processed result of the receive image to the air-conditioning apparatuses 130 and the lighting apparatuses 140.

The ROM 202 is a non-volatile memory. The ROM 202 is configured to store various types of programs, data, and the like that are necessary for the CPU 201 to execute a program to cause the CPU 201 to function as the apparatus manager 210. Specifically, the ROM 202 is configured to store startup programs such as a basic input/output system (BIOS) and an extensible firmware interface (EFI).

The RAM 203 is a main storage device such as a dynamic random access memory (DRAM) or a static random access memory (SRAM). The RAM 203 is configured to serve as a work area in which a program functioning as the apparatus manager 210 is deployed when the program is executed by the CPU 201.

The storage device 204 is configured to store (maintain) the program functioning as the apparatus manager 210, employees' information 220, and layout information 230.

The apparatus manager 210 includes a facial recognition part 211 configured to perform a facial recognition process, an environment manager 212 configured to perform an environmental management process, and an apparatus controller 213 configured to perform an apparatus control process. Note that a detailed description is given later of the facial recognition process performed by the facial recognition part 211, the environmental management process performed by the environment manager 212, and the apparatus control process performed by the apparatus controller 213.

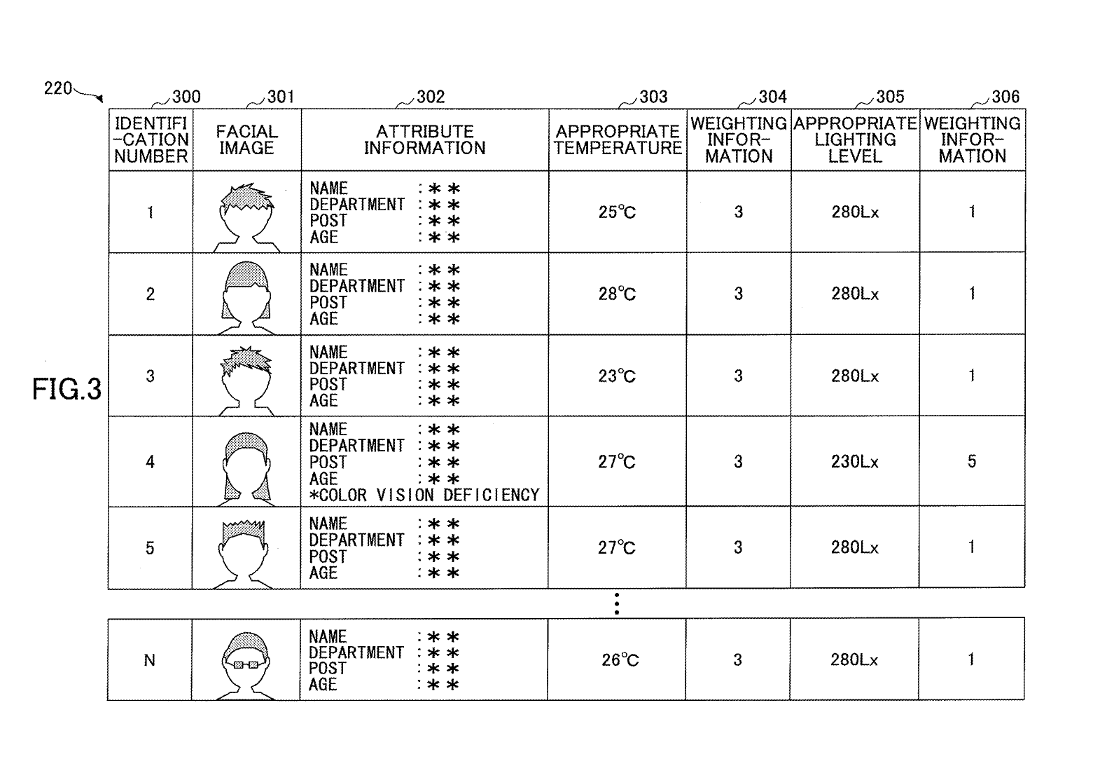

The employees' information 220 is a database to manage all the employees in the office. FIG. 3 is a diagram illustrating one example of the employees' information 220. As illustrated in FIG. 3, the employees' information 220 registers an identification number 300 of each employee in association with a facial image 301, attribute information 302, an appropriate temperature 303, appropriate temperature weighting information 304, an appropriate lighting level 305, and appropriate lighting level weighting information 306.

The attribute information 302 includes a name, a department, a post, an age, and attribute information (together with attribute information such as “color vision deficiency”) of each employee. The appropriate temperature 303 registers the temperature at which each employee feels comfortable. The appropriate temperature weighting information 304 registers one of five levels of appropriate temperature weighting information selected by each employee. Specifically, a level 5 indicates a highest level (most comfortable) and a level 1 indicates a lowest level (most uncomfortable). The appropriate temperature weighting information 304 is configured to prioritize the highest level.

The appropriate lighting level 305 registers the lighting level at which each employee feels comfortable. The appropriate lighting level weighting information 306 registers one of five levels of appropriate lighting level weighting information selected by each employee. Specifically, a level 5 indicates a highest level (most comfortable) and a level 1 indicates a lowest level (most uncomfortable). The appropriate lighting level weighting information 306 is configured to prioritize the highest level. Note that the employee with the identification number “4” has color vision deficiency and his or her appropriate lighting level to acquire clear vision is predetermined. Hence, his or her appropriate lighting level weighting information 306 is predetermined at the level “5”.

The employees' information 220 is used when the apparatus manager 210 specifies the employees in the control area based on the captured image received from the teleconferencing system 120. Further, the employees' information 220 is referred to as parameters (i.e., appropriate temperature and appropriate lighting level) of a work environment desired by each of the employees in the control area when the apparatus manager 210 calculates control information (i.e., lighting level setting value and temperature setting value) for controlling the air-conditioning apparatuses 130 and the lighting apparatuses 140. That is, the employees' information 220 is used as a database indicating a relationship between the employees and parameters of the work environment desired by the employees.

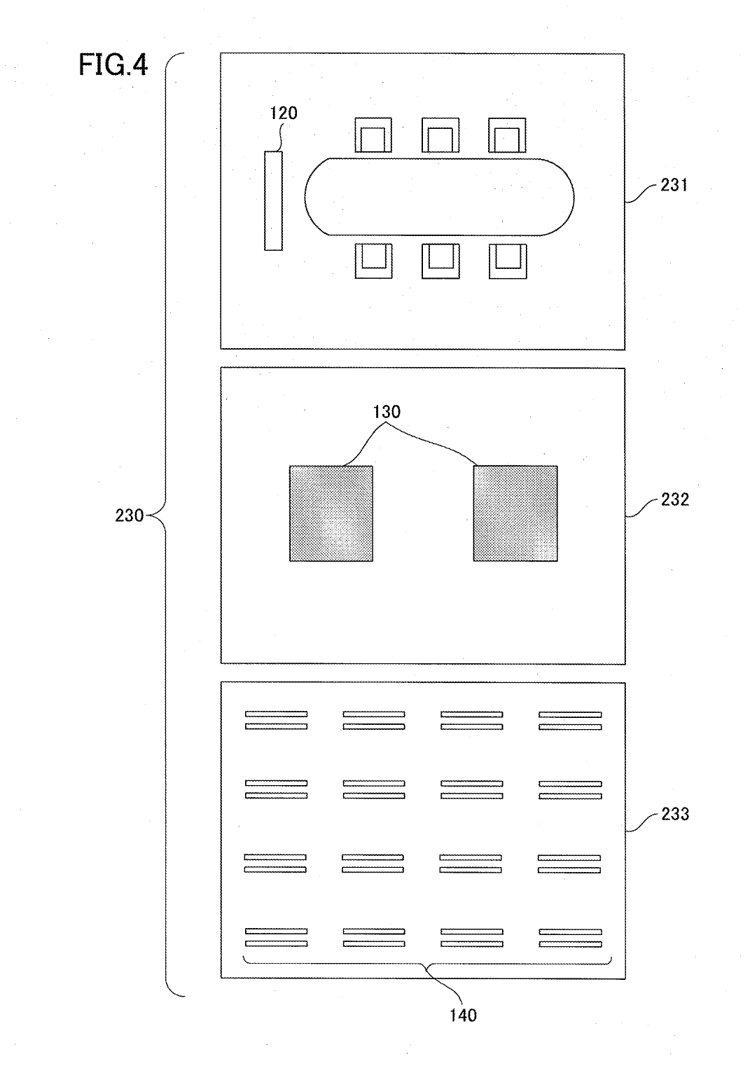

The layout information 230 indicates a layout of the control area. FIG. 4 is a diagram illustrating a layout of a conference room as an example of the control area. As illustrated in FIG. 4, the layout information 230 includes apparatus layout information 231 illustrating a layout of the teleconferencing system 120, a table, chairs, and the like installed in the control area (e.g., a conference room). Further, the layout information 230 includes air-conditioning layout information 232 illustrating a layout of the air-conditioning apparatuses 130 and lighting layout information 233 illustrating a layout of the lighting apparatuses 140.

The layout information 230 is used when the apparatus manager 210 specifies locations of the employees in the control area. Further, the layout information 230 is used when the apparatus manager 210 calculates temperature setting values of the air-conditioning apparatuses 130 and lighting level setting values of the lighting apparatuses 140.

The following description is given by referring back to FIG. 2. The input-output part 205 is configured to input various instructions into the apparatus management device 110 or display an internal status of the apparatus management device 110.

The communications part 206 is configured to receive the captured image transmitted by the teleconferencing system 120 via the network 150. Further, the communications part 206 is configured to transmit via the network 150 the control information (temperature setting values and lighting level setting values) calculated by processing the received captured image.

### Apparatus Management Process Performed by Apparatus Management Device

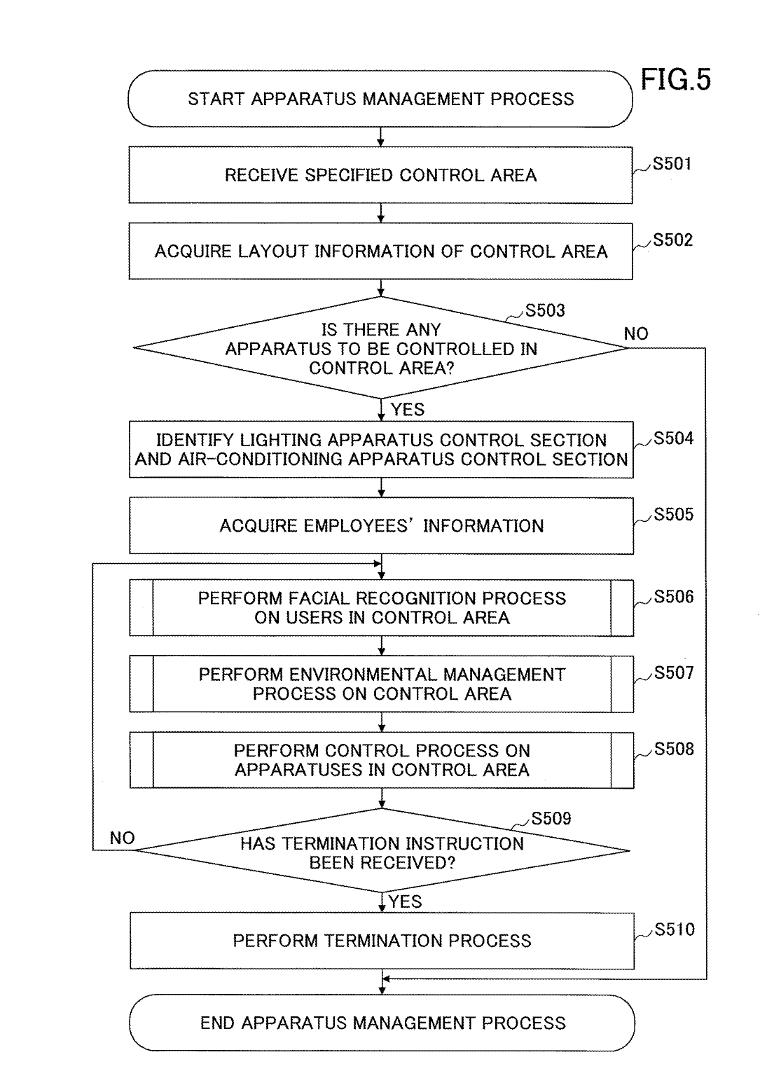

Next, a description is given of an apparatus management process performed by the apparatus management device 110. FIG. 5 is a flowchart illustrating the apparatus management process performed by the apparatus management device 110. In the apparatus management device 110, when the program functioning as the apparatus manager 210 is executed, steps of the flowchart illustrated in FIG. 5 are performed.

In step S501, the input-output part 205 receives specification of a control area. There are plural control areas within the office, and a specified one of the control areas that is subject to an apparatus management process is received in step S501.

In step S502, the layout information 230 of the specified control area is read. Further, in step S503, whether there is any apparatus to be controlled in the specified control area is determined based on the read layout information 230.

In step S503, when it is determined that there is no apparatus to be controlled in the specified control area (“NO”), the apparatus management process is terminated. On the other hand, in step S503, when it is determined that there is an apparatus to be controlled in the specified control area (“YES”), step S504 is processed.

Note that the air-conditioning apparatuses 130 and the lighting apparatuses 140 are each registered as an “apparatus to be controlled” in the apparatus layout information 231 and the air-conditioning layout information 232 included in the layout information 230. Hence, it is determined that there are apparatuses to be controlled in the control area in step S503.

In step S504, control sections of the specified control area are identified based on the layout information 230 read in step S502. Specifically, air-conditioning control sections of the specified control area are identified based on the air-conditioning layout information 232 included in the layout information 230. Further, lighting level control sections of the specified control area are identified based on the lighting layout information 233 included in the layout information 233.

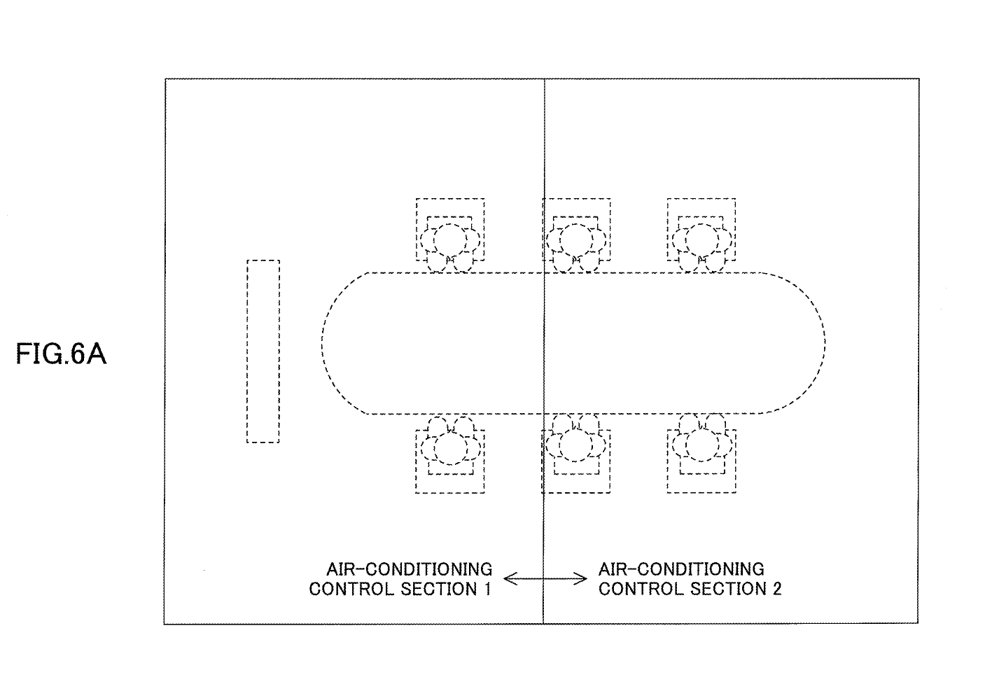

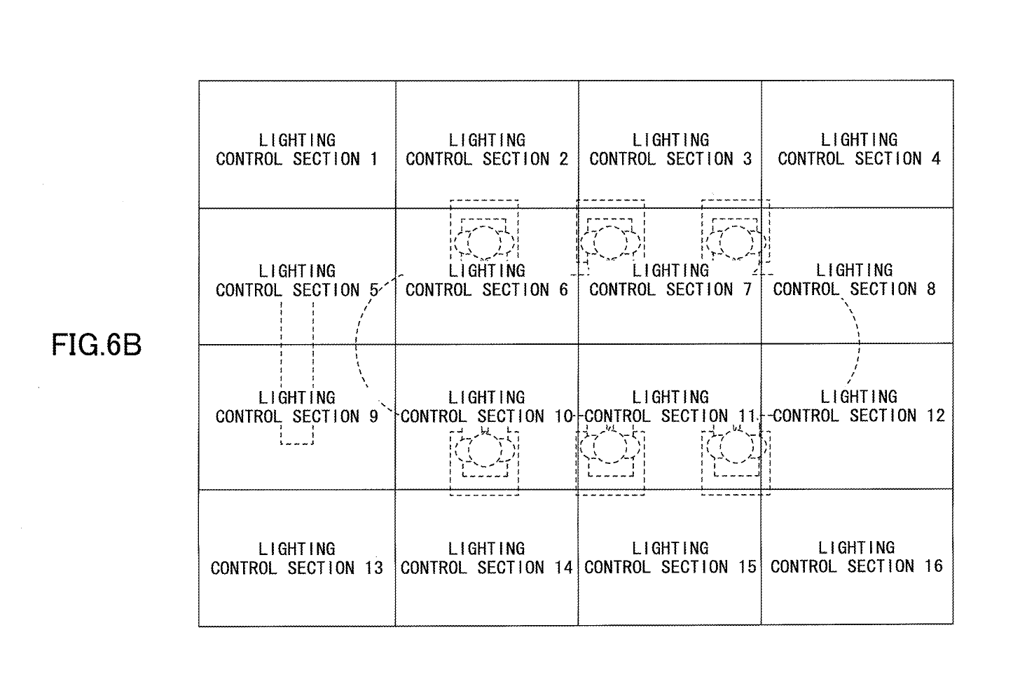

FIG. 6A is a diagram illustrating air-conditioning control sections identified in step S504. When there are two air-conditioning apparatuses 130, the conference room serving as an example of the control area is divided into two air-conditioning control sections.

FIG. 6B is a diagram illustrating lighting apparatus control sections identified in step S504. When the lighting apparatuses 140 are installed in 16 places (positions), the conference room serving as the example of the control area is divided into 16 lighting level control sections.

The following description is given by referring back to FIG. 5. In step S505, the employees' information 220 of the specified control area is read. Further, in step S506, the facial recognition part 211 of the apparatus manager 210 acquires a captured image from the teleconferencing system 120 installed in the specified control area and performs a facial recognition process based on the acquired image and the employees' information 220. Accordingly, the employees in the specified control area are specified. Further, respective locations (positions) of the specified employees in the control area are specified.

In step S507, an environmental management process is performed. Specifically, the environment manager 212 of the apparatus manager 210 extracts from the employees' information an appropriate temperature and an appropriate lighting level of an employee specified as one in the specified control area. Further, a target temperature and a target lighting level of the specified control area are determined based on the extracted appropriate temperature and appropriate lighting level.

In step S508, an apparatus control process is performed. Specifically, the apparatus controller 213 calculates a temperature setting value of the air-conditioning apparatus 130, and a lighting level setting value of the lighting apparatus 140 installed in the specified control area in order to implement the target temperature and the target lighting level determined in step S507. Note that when there are two or more air-conditioning apparatuses 130 and two or more lighting apparatuses 140 in the specified control area, the apparatus controller 213 calculates respective temperature setting values of the air-conditioning apparatuses 130, and respective lighting level setting values of the lighting apparatuses 140.

Further, the apparatus controller 213 transmits the calculated temperature setting values and the calculated lighting level setting values as the control information to the air-conditioning apparatuses 130 and the lighting apparatuses 140, respectively.

In step S509, it is determined whether an instruction (a termination instruction) to terminate the apparatus management process in the specified control area has been received. In step S509, when it is determined that the instruction to terminate the apparatus management process in the specified control area has not been received (“NO”), steps S506 to S509 are repeatedly processed. Note that steps S506 to S509 are performed with a predetermined control cycle (e.g., cycle per second).

On the other hand, when it is determined that the instruction to terminate the apparatus management process in the specified control area has been received in step S509 (“YES”), step S510 is processed.

The instruction to terminate the apparatus management process in the specified control area may, for example, be input into the apparatus management device 110 by being accessed by the employee via his or her predetermined terminal. However, the instruction to terminate the apparatus management process is not necessarily input into the apparatus management device 110 by being accessed by the employee via his or her predetermined terminal, and may be directly input by the employee via the input-output part 205 of the apparatus management device 110.

Alternatively, a utilization time for the specified control area is registered in advance, and when the apparatus management device 110 determines that the utilization time has reached the end of the utilization time, the apparatus management device 110 may be configured to determine that the termination instruction has been received.

Further, the apparatus management device 110 may alternatively be configured to determine that the termination instruction has been received when the power of the teleconferencing system 120 connected to the apparatus management device 110 via the network is switched off, or the transmission of the captured image is stopped.

Moreover, the apparatus management device 110 may alternatively be configured to determine that the termination instruction has been received when the apparatus management device 110 has detected that the power of the air-conditioning apparatus 130 or the lighting apparatus 140 installed in the specified control area is switched off.

In step S510, a termination process is performed. In step S509, when the employee inputs the termination instruction, the apparatus management device 110 transmits respective default values to the air-conditioning apparatus 130 and the lighting apparatus 140 as the control information. As a result, the air-conditioning apparatus 130 and the lighting apparatus 140 installed in the specified control area restore initial statuses before the apparatus management process has started.

Note that the termination process is not limited to that described above. The termination process may, for example, be configured such that the apparatus management device 110 transmits control information to switch off the power of the teleconferencing system 130, the power of the air-conditioning apparatus 130, and the power of the lighting apparatus 140 as the control information.

### Facial Recognition Process Performed by Facial Recognition Part

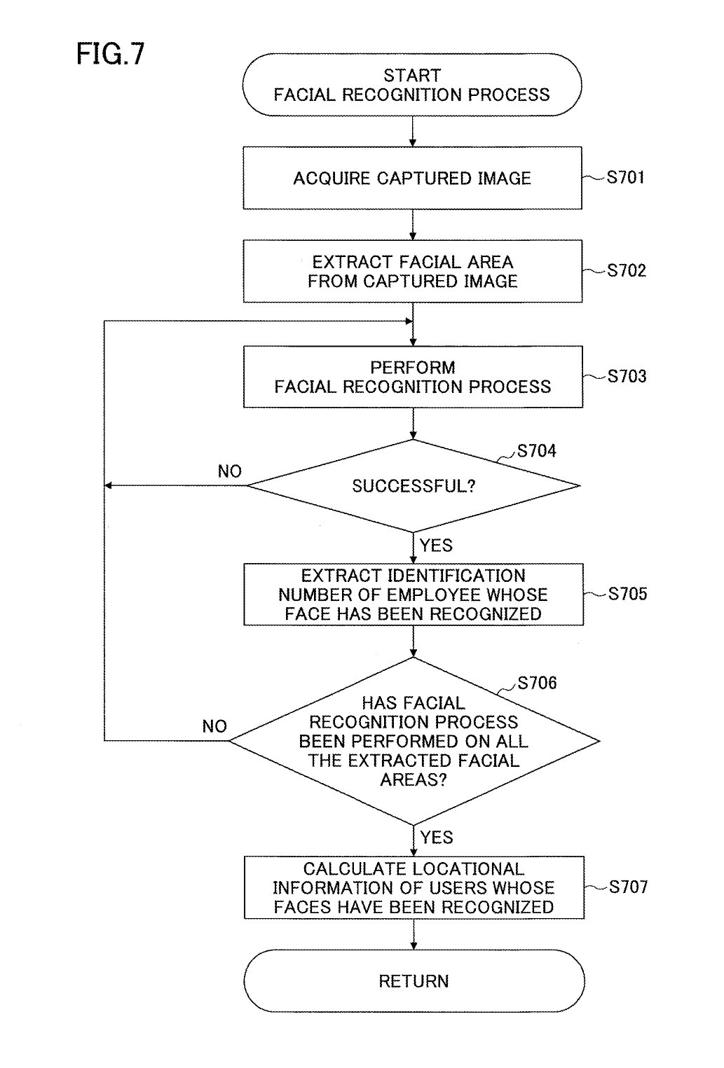

Next, a detailed description is given of a facial recognition process (step S506) performed by the facial recognition part 211. FIG. 7 is a flowchart illustrating details of the facial recognition process (step S506) performed by the facial recognition part 211.

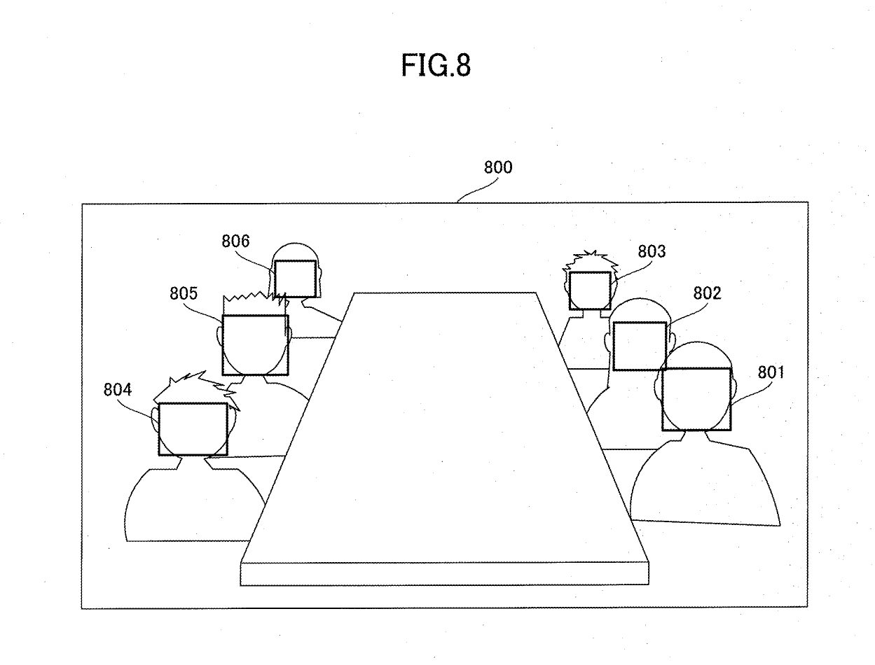

In step S701, the facial recognition part 211 acquires an image captured by the teleconferencing system 120 and transmitted via the network 150. FIG. 8 illustrates an example of an acquired captured image 800. The captured image 800 is a scene of six employees in a conference room that is an example of the control area.

In step S702, facial areas of the six employees are extracted from the acquired captured image. In the captured image 800 of FIG. 8, rectangular areas 801 to 806 indicate the extracted facial areas. Note that a technique to extract facial areas from the captured image 800 is well known in the art, a detailed description the technique is omitted from the specification.

In S703, a facial recognition process is performed on each of the facial areas extracted in step S702 based on the employees' information 220. In this step, the similarity between the amount of a characteristic extracted from an image of the facial area (a facial area image) indicated by the rectangular area 801 and the amount of a characteristic extracted from the facial image registered in the employees' information 220 is calculated. Then, the identification number having a facial image associated with it and the facial image having the highest similarity being a predetermined threshold or above is specified.

In step S704, whether the facial recognition process is successful is determined by determining whether the identification number is specified in association with the rectangular area 801. For example, when there is no facial image having the similarity being the predetermined threshold or above among the facial images registered in the employees' information 220, the facial recognition process is determined to be a failure, and step S703 is processed (back to step S703).

On the other hand, when the identification number is specified in association with the rectangular area 801 (“YES”), the facial recognition process is determined to be successful, and step S705 is processed. In step S705, the specified identification number is extracted from the employees' information 220.

In step S706, it is determined whether the facial recognition process is performed on all the rectangular areas extracted in step S702. In step S706, when it is determined that there remain rectangular areas on which the facial recognition process has not been performed (“NO”), step S703 is processed to perform the facial recognition process on a subsequent one of the remaining rectangular areas. In this step, the similarity between the amount of a characteristic extracted from an image of the facial area indicated by the rectangular area 802 and the amount of a characteristic extracted from the facial image registered in the employees' information 220 is calculated. Then, the identification number having a facial image with it, and the facial image having the highest similarity being a predetermined threshold or above is specified.

Subsequently, the facial recognition process is sequentially processed on the remaining rectangular areas 803 to 806, and when it is determined that the facial recognition process is performed on all the rectangular areas (“YES”), step S707 is processed.

In step S707, locational information is calculated based on respective locations of the rectangular areas 801 to 806 and the layout information 230 (i.e., the apparatus layout information 231). The location information indicates respective positions of the employees within the control area.

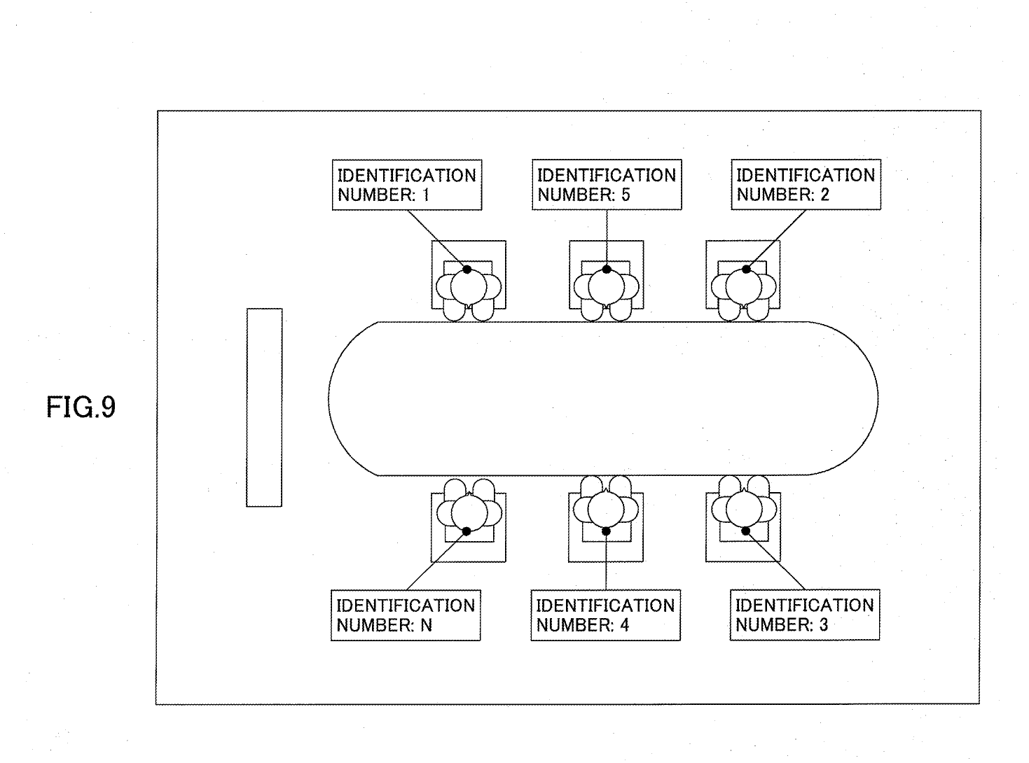

FIG. 9 is a diagram illustrating the respective positions of the employees in the control area that are mapped on the apparatus layout information 231 based on the locational information calculated in step S707. The example of FIG. 9 illustrates a case where the facial recognition process is successful with respect to all the rectangular areas 801 to 806, and the identification numbers associated with the rectangular areas 801 to 806 are specified. In the apparatus management device 110, the respective positions of the employees in the control area may be specified by executing the facial recognition process (step S506).

### Environmental Management Process Performed by Environment Manager

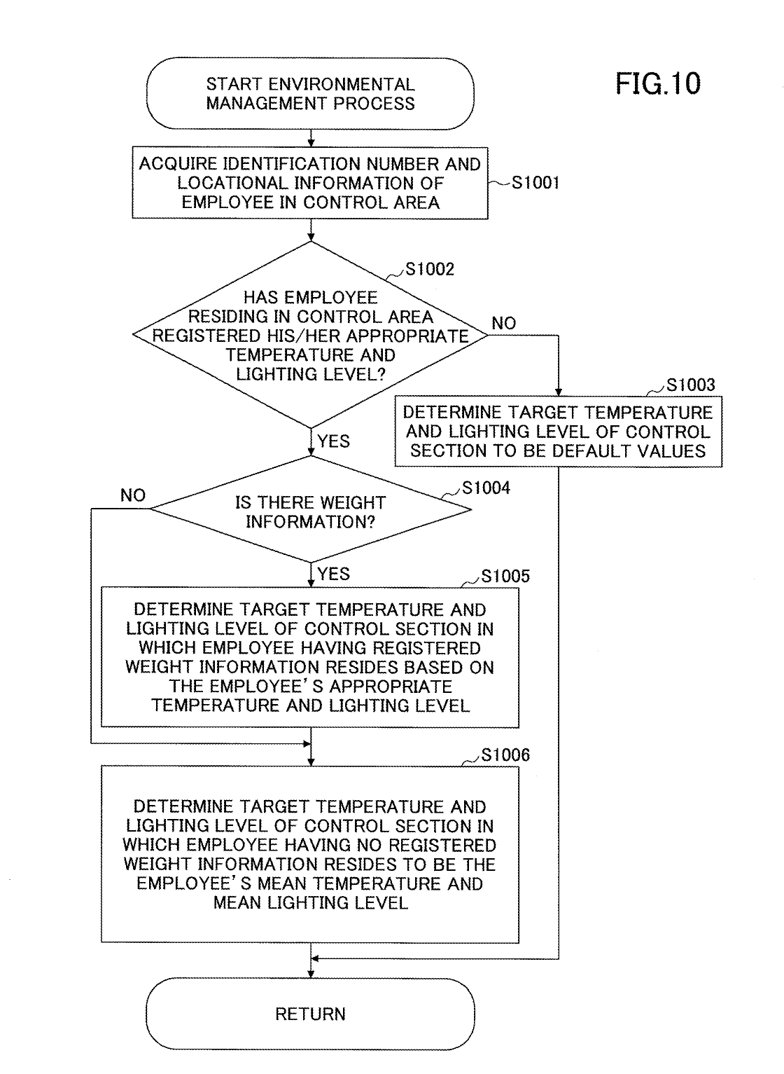

Next, a detailed description is given of an environmental management process (step S507) performed by the environment manager 212. FIG. 10 is a flowchart illustrating details of the environmental management process (step S507) performed by the environment manager 212.

In step S1001, the identification numbers and the locational information of the employees in the control area are acquired. In step S1002, it is determined whether the employees in the control area have registered their appropriate temperatures and appropriate lighting levels in the employees' information 220 (or whether the employees reside in the control section of the control area in the first place). In step S1002, when it is determined that any one of the employees in the control area has not registered his or her appropriate temperature and appropriate lighting level of the employees' information 220 (“NO”) (or it is determined that there is no employee in the control section), step S1003 is processed.

In step S1003, a target temperature of each of the air-conditioning control sections within the control area is determined to be a default value. Likewise, a target lighting level of each of the lighting control sections within the control area is determined to be a default value.

On the other hand, when it is determined that any one of the employees within the control area has registered his or her appropriate temperature and appropriate lighting level of the employees' information 220 (“YES”), step S1004 is processed.

In step S1004, it is determined whether weighting information is registered in association with the registered appropriate temperature or the registered appropriate lighting level. In step S1004, when it is determined that the weighting information has been registered in association with the registered appropriate temperature or the registered appropriate lighting level (“YES”), step S1005 is processed.

In step S1005, the target temperature or the target lighting level of the control section in which the employee having registered in association with his or her registered appropriate temperature or his or her registered appropriate lighting level resides are determined based on his or her appropriate temperature or appropriate lighting level registered in the employees' information 220.

Specifically, when there is an employee having the weighting information registered in association with the registered appropriate temperature or the appropriate lighting level residing alone in the control section, one of his or her appropriate temperature and appropriate lighting level registered in the employees' information 220 is determined to be set at a corresponding one of the target temperature and the target lighting level of the control section. Similarly, when there are an employee having the registered weighting information and an employee having no registered weighting information in the control section, one of his or her appropriate temperature and appropriate lighting level registered in the employees' information 220 is determined to be set at a corresponding one of the target temperature and the target lighting level of the control section.

Further, when there are plural employees having their weighting information registered in association with their registered appropriate temperatures or their registered appropriate lighting levels in the same control section, a highest one of their or their appropriate temperatures and their appropriate lighting levels registered in the employees' information 220 is determined to be set at a corresponding one of the target temperature and the target lighting level of the control section.

Further, when there are plural employees having their weighting information registered in association with their registered appropriate temperatures or registered appropriate lighting levels in the same control section, a highest one of their or their appropriate temperatures and their appropriate lighting levels registered in the employees' information 220 is determined to be set at a corresponding one of the target temperature and the target lighting level of the control section.

In step S1006, a target temperature of the air-conditioning control section in which the employee having no registered weighting information resides is determined. Specifically, a mean of the appropriate temperature registered in the employees' information 220 by the employee having no registered weighting information and the appropriate temperature registered in the employees' information by another employee who resides in the same air-conditioning control section is calculated, and the calculated mean of the appropriate temperatures is determined to be set at the target temperature of the air-conditioning control section.

Similarly, a target lighting level of the lighting level control section in which the employee having no registered weighting information resides is determined. Specifically, a mean of the appropriate lighting level registered in the employees' information 220 by the employee having no registered weighting information and the appropriate lighting level registered in the employees' information by another employee who resides in the same lighting level control section is calculated, and the calculated mean of the appropriate temperatures is determined to be set at the target temperature of the lighting level control section.

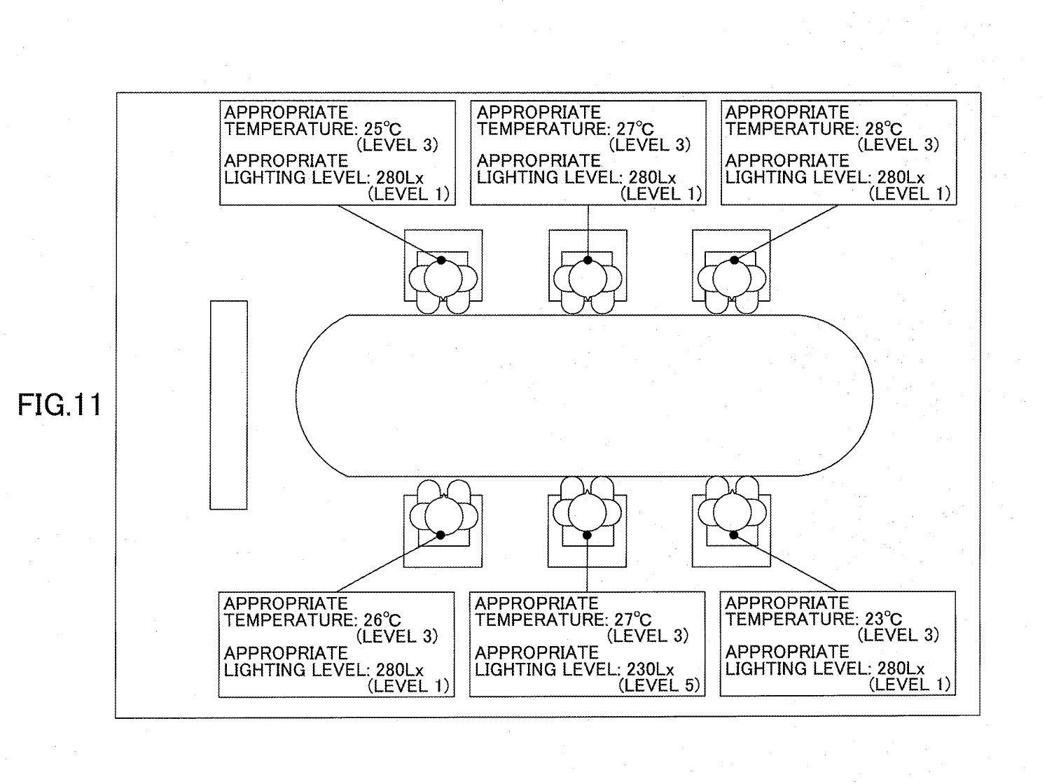

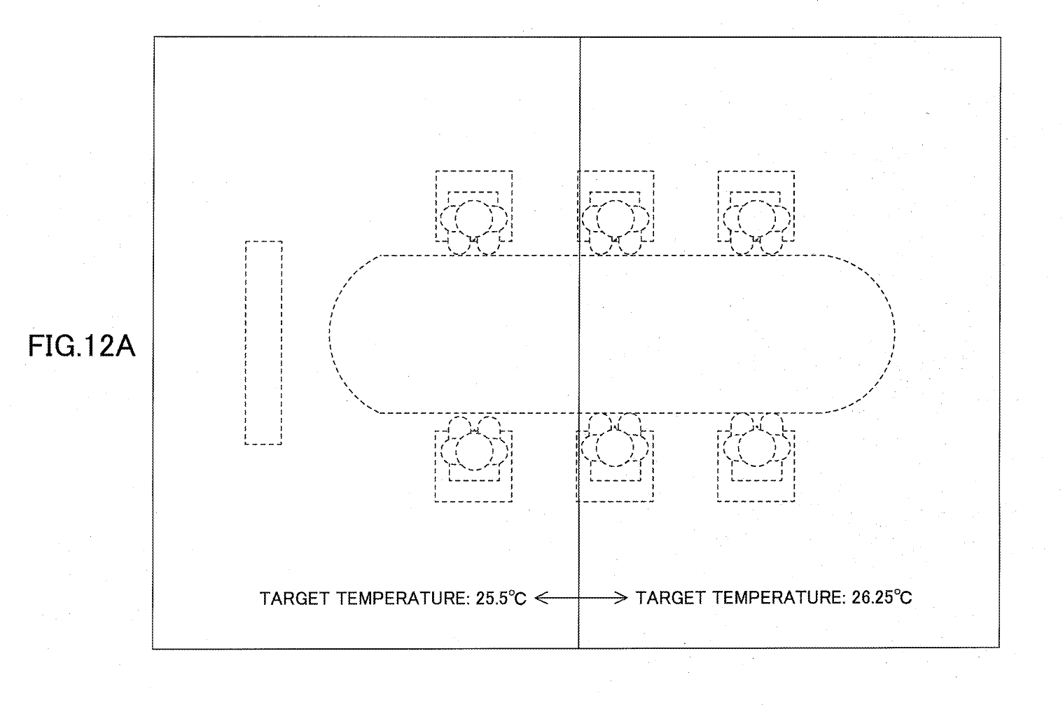

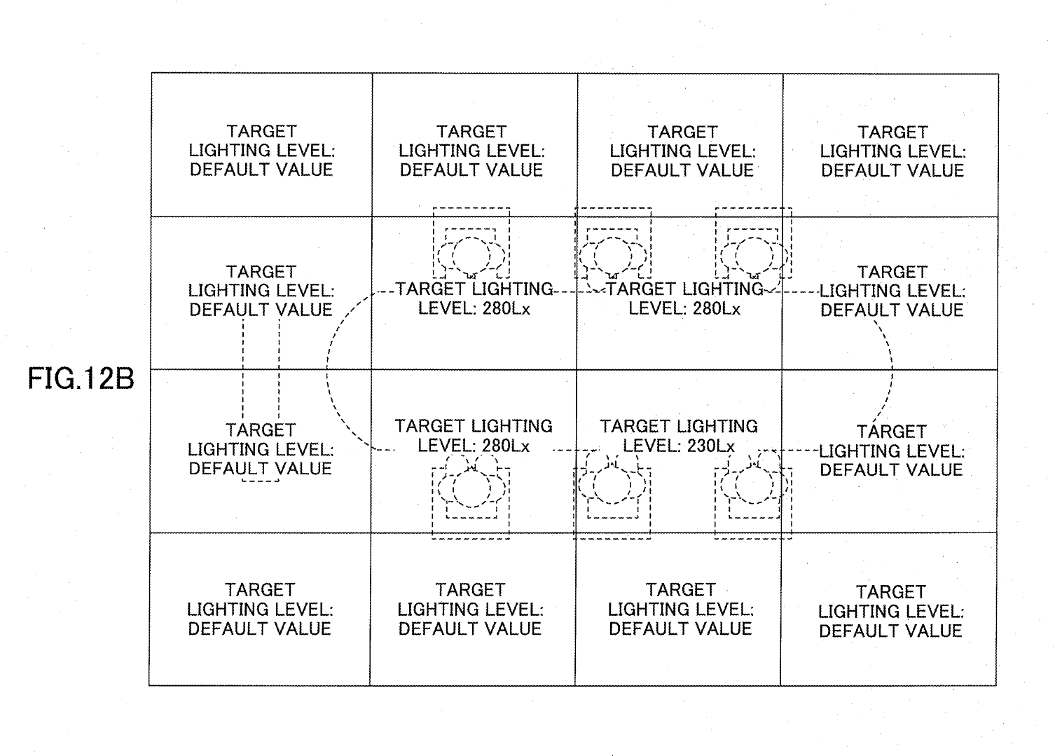

FIG. 11 is a diagram illustrating respective appropriate temperatures 303, appropriate temperature weighting information 304, appropriate lighting levels 305, and appropriate lighting level weighting information 306 in the employees' information registered by the employees who reside in the control area. Further, FIGS. 12A and 12B are diagrams illustrating examples of target temperatures and target lighting levels of the control sections (air-conditioning sections 1 and 2; lighting control sections 1 to 16) determined based on the appropriate temperatures 303, appropriate temperature weighting information 304, appropriate lighting levels 305, and appropriate lighting level weighting information 306 illustrated in FIG. 11.

As illustrated in FIGS. 12A and 12B, the target temperatures and the target lighting levels of the air-conditioning sections and lighting control sections constructing the control area, which correspond to the positions of the employees, are determined based on the appropriate temperatures 303, appropriate temperature weighting information 304, appropriate lighting levels 305, and appropriate lighting level weighting information 306 in the employees' information registered by the employees. Further, the target temperatures and the target lighting levels of the air-conditioning sections and lighting control sections corresponding to the positions at which no employees are located determined based on respective default values of the temperature and lighting level.

### Apparatus Control Process Performed by Apparatus Controller

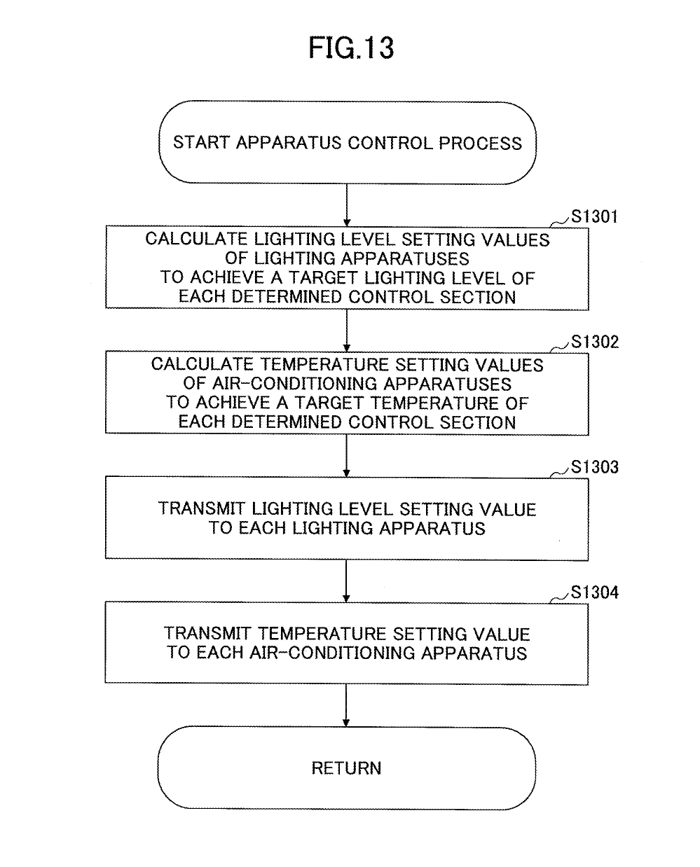

Next, a detailed description is given of an apparatus control process (step S508) performed by the apparatus controller 213. FIG. 13 is a flowchart illustrating details of the apparatus control process (step S508) performed by the apparatus manager 213.

In step S1301, a lighting level setting value of each of the lighting apparatuses 140 is calculated in order to implement the target lighting level of a corresponding one of the control sections determined in the environmental management process (step S507). The lighting level of each of the control sections is affected by the lighting level of the lighting apparatus 140 installed in the corresponding control section and the lighting levels of its peripheral lighting apparatuses 140 installed at the periphery of the control section. Accordingly, in the apparatus controller 213, the lighting level setting value of each of the lighting apparatuses 140 is calculated by considering the lighting levels of its peripheral lighting apparatuses 140 in order to implement the determined target lighting level of a corresponding one of the control sections.

In step S1302, a temperature setting value of each of the air-conditioning apparatuses 130 is calculated in order to implement the target temperature of a corresponding one of the control sections determined in the environmental management process (step S507). The temperature of one of the control sections is affected by the temperature of the air-conditioning apparatus 130 installed in the corresponding control section and the temperature of the air-conditioning apparatus 130 installed in the adjacent control section. Accordingly, in the apparatus controller 213, the temperature setting value of each of the air-conditioning apparatuses 130 is calculated by considering the temperature of its adjacent air-conditioning apparatus 130 in order to implement the determined target temperature of the corresponding one of the control sections.

In step S1303, the lighting level setting value calculated in step S1301 is transmitted as the control information to the lighting apparatus 140. In step S1304, the temperature setting value calculated in step S1302 is transmitted as the control information to the air-conditioning apparatus 130.

Note that each of the lighting apparatuses 140 is configured to operate based on the received control information (i.e., the lighting level setting value). Likewise, each of the lighting apparatuses 130 is configured to operate based on the received control information (i.e., the temperature setting value).

### Outline

As described above, the apparatus management system 100 according to the first embodiment is:

configured to register a facial image of each of the employees in the office as the employees' information;

is further configured to register an appropriate temperature and an appropriate lighting level at which each of the employees feels comfortable, and respective weighting information with respect to the appropriate temperature and the appropriate lighting level of a corresponding one of the employees at which the employee feels comfortable;

is configured to store apparatus layout information, air-conditioning layout information, lighting layout information as layout information of each of the control areas, and identify the air-conditioning control sections and the lighting level control sections of a corresponding one of the control area;

is configured to specify the employees and to calculate locational information of the specified employees based on the captured image acquired by imaging the control area by utilizing the teleconferencing system installed in each of the control area;

is configured to determine the target temperature of each of the air-conditioning control sections and the target lighting level of each of the lighting level control sections based on the appropriate temperature and the appropriate lighting level registered by each of the employees in the control area, respective weighting information with respect to the appropriate temperature and the appropriate lighting level, and locational information of a corresponding one of the employees; and

is configured to calculate the temperature setting value of each of the air-conditioning apparatus and the lighting level setting value of each of the lighting apparatuses based on the target temperature of each of the air-conditioning control sections and the target lighting level of each of the lighting level control sections, and to transmit the calculated temperature setting value and lighting level setting value as the control information to a corresponding one of the air-conditioning apparatuses and one of the apparatuses.

Hence, it may be possible to control a work environment such as the temperature and the lighting level of the control area by adding the preferences or attributes of each of the employees. As a result, comfortableness of each the employees may be improved.

### Second Embodiment

In the apparatus management system 100 of the first embodiment, the apparatus management device 110 is configured to control the temperature setting values of the air-conditioning apparatuses 130. However, the invention is not limited to this configuration. The apparatus management device 110 may be configured to control air direction setting values of the air-conditioning apparatuses 130 in addition to the temperature setting values.

Further, the first embodiment illustrates the configuration of the apparatus management system 100 where the facial recognition process has been successful with respect to all the employees in the control area. However, the invention is not limited to this configuration. The facial recognition process has not necessarily been successful with respect to all the employees in the control area in the apparatus management system 100. In this case, the appropriate temperatures and the appropriate lighting levels for those employees on which the facial recognition process has not been successful are not extracted. Hence, respective default values are set at the target temperature and the target lighting level of the control section in which those employees reside. Note that when there is an employee on which the facial recognition process has been successful in the same control area, the appropriate temperature and the appropriate lighting level of this employee is determined to be the target temperature and the target lighting level.

In addition, the first embodiment describes a configuration of the apparatus management system 100 where all the employees remain in their original positions of the control area while the apparatus management process is performed. However, the invention is not limited to this configuration. For example, when the employee in the control area moves to a different position (another control section) within the same control area, the apparatus management process is performed on the image captured after the employee has moved to the different position within the same control area. Further, when the employee in the control area moves outside the control area, the apparatus management process is performed on the image captured after the employee has moved outside the control area (i.e., the captured image includes no image of this employee who has moved outside the control area).

Thus, the apparatus management process performed by the apparatus management device 110 may flexibly calculate the temperature setting value and the lighting level setting value of each of the control sections of accordance with the individual movements of the employees.

Moreover, the first embodiment describes the configuration of the apparatus management system 100 where the apparatus management process is performed on the employees in one office. However, the invention is not limited to this configuration. For example, when two or more offices are present in one floor or in one building, the apparatus management process may be configured to be performed on respective groups of the employees of two or more offices.

Further, the first embodiment describes the configuration of the apparatus management system 100 where an office or the like is subject to execution of the apparatus management process. However, the invention is not limited to this configuration. For example, indoor commercial facilities other than the office may be subject to execution of the apparatus management process.

In addition, in the apparatus management system 100 of the first embodiment, the employees' information 220 is configured to register the appropriate temperature and the appropriate lighting level of each of the employees. However, the invention is not limited to this configuration. For example, when there are two or more workspaces within the office, the employees' information 220 is configured to register the appropriate temperature and the appropriate lighting level of each of the workspaces.

Further, the first embodiment describes the configuration of the apparatus management system 100 where one control area is divided into two or more control sections based on the number of air-conditioning apparatuses and the number of lighting apparatuses to determine the respective target temperatures for the control sections divided based on the number of air-conditioning apparatuses and the respective target lighting levels for the control sections divided based on the number of lighting apparatuses. However, the invention is not limited to this configuration. For example, the target temperature and the target lighting level may be configured to be determined based on one control section regardless of the number of the air-conditioning apparatuses and the number of the lighting apparatuses.

Note that the apparatus management system 100 of the first embodiment describes the configuration where the apparatus management device 110 includes the apparatus manager 210, the employees' information 220, and the layout information 230. However, the invention is not limited to this configuration. For example, another apparatus connected to the network 150 may include the apparatus manager 210 (or a function of a part of the apparatus manager 210), the employees' information 220, and the layout information 230.

### Third Embodiment

In the first and the second embodiments, the apparatus manager 210 is configured to execute a sequence of processes up to transmission of the control information to air-conditioning apparatuses or lighting apparatuses. However, the invention is not limited to these configurations. For example, the apparatus manager 210 may further be configured to execute a process such as management of an apparatus control process history and the like by utilizing the control information transmitted to the air-conditioning apparatuses or lighting apparatuses.

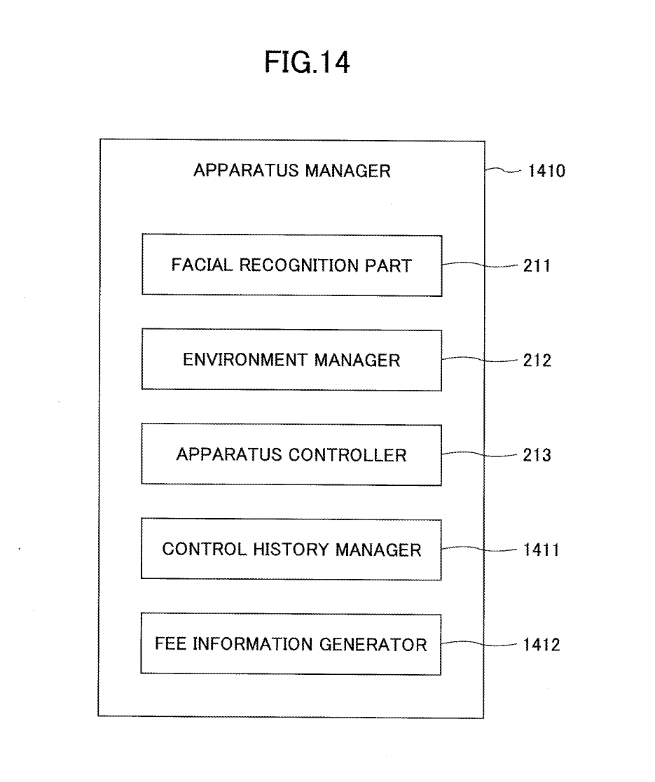

FIG. 14 is a diagram illustrating another functional configuration of an apparatus manager 1410. As illustrated in FIG. 14, the apparatus manager 1410 includes a control history manager 1411, and a fee information generator 1412 in addition to the facial recognition part 211, the environment manager 212, and the apparatus controller 213.

The control history manager 1411 is configured to manage a history of the apparatus control process performed by the apparatus controller 213. Specifically, when the termination process is performed in step S510 of FIG. 5, the control history manager 1411 stores executed contents of the apparatus control process as control history information.

The fee information generator 1412 generates fee usage information in a predetermined control area by utilizing the control history information managed by the control history manager 1411 and not-illustrated predetermined fee information. Further, the fee information generator 1412 outputs the generated fee usage information to a predetermined output destination via the communications part 206.

Hence, the various types of processes based on the control history information may be implemented by managing the history of the apparatus control process executed by the apparatus control device 110 as the control history information.

The above-described first to third embodiments may be able to improve comfortableness of workspace.

The present invention is not limited to the specifically disclosed embodiments or combinations of the embodiments. Variations and modifications may be made without departing from the scope of the present invention.

The embodiments of the present invention are described above. However, the present invention is not limited to the specifically disclosed embodiments, and variations and modifications may be made without departing from the scope of the present invention.

The present application is based on Japanese Priority Application No. 2013-200495 filed on Sep. 26, 2013, and Japanese Priority Application No. 2014-101448 filed on May 15, 2014, the entire contents of which are hereby incorporated herein by reference.

What is claimed is:

1. An apparatus management device configured to manage one or more apparatuses that control a work environment of a workspace, the apparatus management device comprising:
a storage part configured to store an associated relationship between the users and parameters indicating the work environment;
an apparatus management part configured to specify a user in the workspace from an image of the workspace;
a calculating part configured to calculate a setting value for controlling the work environment based on a parameter stored in association with the user specified by the apparatus management part; and
a transmitting part configured to transmit the setting value calculated by the calculating part to one of the apparatuses that control the work environment.

2. The apparatus management device as claimed in claim 1, wherein
the apparatus management part specifies the user in the workspace based on facial images of the users stored in storage part and facial area images extracted from the image of the workspace.

3. The apparatus management device as claimed in claim 1, wherein
the apparatus management part is further configured to specify the workspace of the user, the apparatus management device further comprising:
a first determination part configured to determine whether there is an apparatus that controls the work environment of the workspace specified by the apparatus management part, wherein
when the first determination part determines that there is an apparatus that controls the work environment of the workspace specified by the apparatus management part, the apparatus management part acquires an image of the specified workspace.

4. The apparatus management device as claimed in claim 1, further comprising:
a second determination part configured to determine whether the parameter is stored in association with the user specified by the apparatus management part.

5. The apparatus management device as claimed in claim 4, wherein
when the second determination part determines that the parameter is not stored in the storage part, the calculating part calculates a setting value for controlling the work environment based on a default value of the parameter.

6. The apparatus management device as claimed in claim 1, wherein
when there are two or more users specified by the apparatus management part, the calculating part calculates a setting value for controlling the work environment based on the parameters stored in association with the respective users.

7. The apparatus management device as claimed in claim 1, wherein
when there are two or more users specified by the apparatus management part, the calculating part calculates a setting value for controlling the work environment based on a parameter having a highest level of weighting information among the parameters stored in association with the respective users.

8. The apparatus management device as claimed in claim 1, wherein
the parameters indicating the work environment include temperature information and lighting level information in the workspace.

9. An apparatus management system comprising:
one or more apparatuses configured to control a work environment of a workspace;
an imaging part configured to image the workspace for users; and
an apparatus management device configured to manage the apparatuses;
a storage part configured to store an associated relationship between the users and parameters indicating the work environment;
an apparatus management part configured to specify a user in the workspace from the image of the workspace;
a calculating part configured to calculate a setting value for controlling the work environment based on the parameter stored in association with the user specified by the apparatus management part; and
a transmitting part configured to transmit the setting value calculated by the calculating part to one of the apparatuses that control the work environment.

10. A method for controlling an apparatus management system, the apparatus management system including one or more apparatuses configured to control a work environment, an imaging part configured to image the workspace, and an apparatus management device configured to manage the apparatuses, the method comprising:
storing an associated relationship between the users and parameters indicating the work environment;
specifying a user in the workspace from the image of the workspace;
calculating a setting value for controlling the work environment based on the parameter stored in association with the specified user; and
transmitting the calculated setting value to one of the apparatuses that control the work environment.

11. A non-transitory recording medium storing a program, which, when processed by a processor, causes a computer to execute the method as claimed in claim 10.
